(19) United States
(12) Patent Application Publication
(10) Pub. No.: US 2006/0004176 A1
(43) Pub. Date: Jan. 5, 2006

(54) Oligocarbonate polyols having terminal secondary hydroxyl groups

(75) Inventor: Steffen Hofacker, Odenthal (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/165,699

(22) Filed: Jun. 24, 2005

(30) Foreign Application Priority Data
Jul. 1, 2004 (DE) 102004031900.6

(51) Int. Cl. C08G 18/70

(52) U.S. Cl. 528/67

(57) ABSTRACT

The present invention relates to a process for preparing aliphatic oligocarbonate polyols having secondary OH groups and number-average molecular weights ≧500 g/mol, by A) initially reacting excess amounts of organic carbonates with polyols which have exclusively primary OH groups via a transesterification reaction to prepare an intermediate polymer having an average concentration of OH groups of ≦0.3 mol %, based on 1 mol of the intermediate polymer, B) removing the cleavage products formed simultaneously with the transesterification reaction or subsequently together with excess unconverted carbonate, and, in a further step, C) reacting the intermediate polymer with aliphatic polyols which each have at least one secondary OH group per molecule to obtain aliphatic oligocarbonate polyols having an average of ≧5 mol % of secondary OH groups, based on the total of all the OH groups present. The present invention also relates to coatings, dispersions, adhesives or sealants obtained using these aliphatic oligocarbonate polyols.

### BACKGROUND OF THE INVENTION

1. Field of the Invention

The present invention relates to a process for preparing aliphatic oligocarbonate polyols having terminal secondary hydroxyl groups by transesterifying organic carbonates with aliphatic polyols.

2. Description of the Prior Art

Oligocarbonate diols may be prepared in principle from aliphatic polyols by reacting with phosgene, bischlorocarbonic esters, diaryl carbonates, cyclic carbonates or dialkyl carbonates. They are important precursors for the production of plastics, coatings and adhesives. They are reacted, for example, with isocyanates, epoxides, (cyclic) esters, acids or acid anhydrides.

DE-A 101 30 882 teaches, for example, that aliphatic oligocarbonate diols are obtainable by reacting dimethyl carbonate with aliphatic diols under pressure. The diols disclosed therein are exclusively those having primary hydroxyl groups, so that aliphatic oligocarbonates are obtained which exclusively have terminal primary hydroxyl groups.

Furthermore, DE-A 101 56 896 discloses that, to prepare aliphatic oligocarbonate polyols by transesterification of organic carbonates, it is also possible to use polyols having secondary or tertiary hydroxyl groups. There is no description of a separate, stepwise feeding of polyols having primary OH groups and polyols having secondary OH groups.

However, a disadvantage of the preparation processes which are known from the prior art is that, when polyols having secondary hydroxyl functions are used, a transesterification with organic carbonates is effected only with low conversion, which has the consequence that oligocarbonate polyols having average molecular weights greater than 500 g/mol cannot be prepared, or can only be obtained when extremely long transesterification times are accepted. The preparation becomes uneconomical due to the resulting poor space-time yield.

Oligocarbonate polyols having terminal secondary hydroxyl groups are of great interest as reaction partners for highly reactive (poly)isocyanates, for example, in the preparation of aromatic polyisocyanate prepolymers or for the control of the urethanization reaction via different OH reactivities.

It is therefore an object of the present invention to provide an economically useable process for preparing aliphatic oligocarbonate polyols having terminal secondary hydroxyl groups.

This object may be achieved by the multistage process described below.

### SUMMARY OF THE INVENTION

The present invention relates to a process for preparing aliphatic oligocarbonate polyols having secondary OH groups and number-average molecular weights ≧500 g/mol, by
A) initially reacting excess amounts of organic carbonates with polyols which have exclusively primary OH groups via a transesterification reaction to prepare an intermediate polymer having an average concentration of OH groups of ≦0.3 mol %, based on 1 mol of the intermediate polymer,
B) removing the cleavage products formed simultaneously with the transesterification reaction or subsequently together with excess unconverted carbonate, and, in a further step,
C) reacting the intermediate polymer with aliphatic polyols which each have at least one secondary OH group per molecule to obtain aliphatic oligocarbonate polyols having an average of ≧5 mol % of secondary OH groups, based on the total of all the OH groups present.

The present invention also relates to coatings, dispersions, adhesives or sealants obtained using these aliphatic oligocarbonate polyols.

### DETAILED DESCRIPTION OF THE INVENTION

The polymer from stage A) preferably has on average less than 0.2 mol %, more preferably ≦0.1 mol % and most preferably 0-0.05 mol %, of OH groups.

The oligocarbonate polyol obtained after step C) has a content of secondary OH groups based on the total of all OH groups of ≧5 mol %, preferably ≧30 mol % and more preferably 60-95 mol %.

The oligocarbonate polyols obtained after step C) preferably have number-average molecular weights of 500 to 5000 g/mol, more preferably 500 to 3000 g/mol and most preferably 750 to 2500 g/mol.

The oligocarbonate polyols obtained after step C) preferably have average OH functionalities of ≧1.80, more preferably ≧1.90 and most preferably 1.90 to 5.0.

The organic carbonates used in stage A) include aryl carbonates, alkyl carbonates, alkylene carbonates or any mixtures thereof. Examples include diphenyl carbonate (DPC), dimethyl carbonate (DMC), diethyl carbonate (DEC) and ethylene carbonate. Preferred are diphenyl carbonate, dimethyl carbonate and diethyl carbonate. Especially preferred are diphenyl carbonate and dimethyl carbonate.

The primary aliphatic polyols used in stage A) are preferably compounds having 4 to 50 carbon atoms in the chain (branched and/or unbranched), and the chain may also be interrupted by additional heteroatoms such as oxygen (O), sulphur (S) or nitrogen (N). These polyols used in A) preferably have OH functionalities of 2 to 8, more preferably 2 to 4.

Examples of suitable aliphatic primary polyols include 1,4-butanediol, 1,5-pentanediol, 1,6-hexanediol, 1,7-heptanediol, 1,12-dodecanediol, cyclo-hexanedimethanol, 3-methyl-1,5-pentanediol, 2,4-diethyl-1,5-pentanediol, bis(2-hydroxyethyl) ether, bis(6-hydroxyhexyl) ether, dimer diol, trimethylol-propane, pentaerythritol, short-chain polyether polyols having primary hydroxyl groups and a number-average molecular weight ≦700 g/mol, and mixtures thereof.

Also suitable are the addition products or mixtures of the preceding aliphatic primary polyols with lactones (cyclic esters) such as ε-caprolactone or valerolactone.

The aliphatic polyols having at least one secondary hydroxyl group which are used in stage C) are preferably compounds having from 4 to 50 carbon atoms in the chain (branched and/or unbranched), and the chain may also be interrupted by additional heteroatoms such as oxygen (O), sulphur (S) or nitrogen (N). These polyols used in C) preferably have OH functionalities of 2 to 8, more preferably 2 to 4.

Examples of such aliphatic polyols having at least one secondary hydroxyl group include 1,2-propanediol, 1,3-butanediol, 1,2-pentanediol, 1,3-pentanediol, 1,4-pentanediol, 2,3-pentanediol, 2,4-pentanediol, 1,2-hexanediol, 1,3-hexanediol, 1,4-hexanediol, 1,5-hexanediol, 2,3-hexanediol, 2,4-hexanediol, 2,5-hexanediol, 2,2,4-trimethylpentane-1,3-diol, 2,2-bis(4-hydroxycyclohexyl)propane, glucose, sorbitol, short-chain polyether polyols having secondary hydroxyl groups and a number-average molecular weight of ≦700 g/mol, and mixtures thereof.

Compounds known from the prior art which catalyze at transesterification may be used in the process according to the invention. Especially suitable for the process are hydroxides, oxides, metal alkoxides, carbonates, organometallic compounds and complexes of the metals of main groups I, II, III and IV of Mendeleev's Periodic Table of the Elements, and of transition groups II and IV including the rare earths, in particular the compounds of titanium, zirconium, lead, tin, antimony, yttrium and ytterbium.

Examples of suitable catalysts include LiOH, Li₂CO₃, K₂CO₃, Mg₅(OH)₂(CO₃)₄, titanium tetraalkoxides, dibutyltin dilaurate, dibutyltin oxide, bistributyltin oxide, yttrium (III) acetylacetonate and ytterbium(III) acetylacetonate. Preferred catalysts for the transesterification reaction are Mg₅(OH)₂(CO₃)₄, titanium tetraalkoxides, dibutyltin dilaurate, yttrium (III) acetylacetonate and ytterbium(III) acetylacetonate.

If a catalyst is used, its concentration is from 0.01 ppm to 1000 ppm (content of the metal based on the resulting inventive oligocarbonate polyol), preferably from 0.01 ppm to 500 ppm and more preferably from 0.1 ppm to 300 ppm.

The process according to the invention is carried out at temperatures of preferably 50 to 250° C., more preferably 100 to 200° C., and pressures of preferably 0.01 to 10 bar (absolute), more preferably 0.05 to 6 bar (absolute).

Stage C) of the process according to the invention is carried out until the experimentally determined hydroxyl functionality has preferably attained >90%, more preferably >95% of the theoretical value. To accelerate the reaction in stage C), it is possible again to add a transesterification catalyst and/or to conduct the reaction at a pressure of <1013 mbar (absolute).

The amount of organic carbonate or the corresponding polyols used in stage A) depends upon the desired number-average molecular weight (Mn) of the oligocarbonate polyol to be prepared.

It is essential that the organic carbonates in A) are always used in excess based on the primary OH groups present in the polyols, so that after stage A) a substantially OH-free polymer with the aforementioned OH group contents is obtained. The excess of the organic carbonate is preferably 5 to 100 mol %, more preferably 10 to 50 mol %, based on the necessary stoichiometry to prepare the theoretical OH-functional compound.

The transesterification, in stage A) of the process according to the invention, of primary aliphatic polyol and organic carbonate may also be effected in partial steps, in such a way that the organic carbonate is added stepwise to the primary aliphatic polyol and the by-product is removed intermediately, if appropriate, at pressures of less than 1 bar (absolute). Equally possible is continuous metered addition of organic carbonate paired with continuous removal of the by-product.

The reaction time in stage A) is preferably 5 to 100 h, more preferably 10 to 80 h. The reaction time in stage C) is preferably 1 to 50 h, more preferably 5 to 25 h.

The oligocarbonate polyols obtained by the process according to the invention are suitable particularly for the production of coatings, dispersions, adhesives and sealants. The coatings, dispersions, adhesives and sealants may be applied to any known substrates and cured.

### EXAMPLES

The content of terminal secondary hydroxyl groups in the oligocarbonate diol, and also the hydroxyl functionality, were determined by integral evaluation of ¹H NMR spectra of the corresponding products. The target compound used as the basis in each case was the ideal structure resulting from the stoichiometry selected. Initially, the number-average molecular weight (Mₙ) of the particular product was calculated with reference to the integration of the proton resonances of the repeating units in the molecule. This purpose was served by the signals of the methylene groups from the diols used, and the methylene end group of the CH₂—OH group of the oligocarbonate diol was used for normalization. In the same way, the proportion of non-hydroxyl-functional end groups (substantially methyl ester and methyl ether groups) was determined by integration of the corresponding signals and normalization to the methylene end groups. The sum of the molecular weight of the desired oligocarbonate diol and molecular weight of the compounds having non-hydroxy-functional end groups (chain terminators) gives the total molecular weight. The proportions of the chain terminators in the overall compound are calculated correspondingly in mol %. The actual functionality to be determined constitutes the difference of theoretical maximum functionality and content of chain terminators. The proportion of terminal secondary hydroxyl groups was determined analogously.

The hydroxyl number (OHN) was determined according to DIN 53240-2.

The number-average molecular weight (Mₙ) is calculated from the relationship between hydroxyl number and functionality.

The viscosity was determined by means of a VISKOLAB LC-3/ISO rotational viscometer from Physika, Germany according to DIN EN ISO 3219.

### Example 1

295.9 g of 1,6-hexanediol were heated to 120° C. in a multinecked flask having stirrer and reflux condenser, and dehydrated at 2 mbar for 2 h. Subsequently, under a nitrogen blanket, the oil bath was cooled to 110° C., 0.08 g of ytterbium(III) acetylacetonate were added and 363.9 g of dimethyl carbonate were metered in within 20 minutes. On completion of addition, the reaction mixture was kept under reflux for 24 h.

Afterwards, the reaction mixture was distilled, during which the methanol by-product and also traces of dimethyl carbonate were removed. The distillation was effected initially at 150° C. for 4 h and was continued at 180° C. for a further 4 h.

Afterwards, the temperature was reduced to 130° C. and the pressure was lowered to <20 mbar. In addition, a nitrogen stream (2 l/h) was passed through the reaction mixture. Finally, the temperature was increased from 130° C. to 180° C., provided that the top temperature did not exceed 60° C. The reaction mixture was kept at this temperature for 6 h. The hydroxyl number (OHN) of 18.8 mg KOH/g determined afterwards showed that the hydroxyl concentration in the oligocarbonate was still too high. A further 100 g of dimethyl carbonate were then added at an oil bath temperature of 120° C. and the mixture was kept under reflux for 2 h. Afterward, by-product and excess dimethyl carbonate were distilled at 150° C. for 2 h. Finally, the temperature was increased to 180° C. within 6 h and kept there for 1 h.

The resulting oligocarbonate had a hydroxyl number of 0 and thus a hydroxyl concentration of <0.05 mol %.

48.5 g of 1,3-butanediol were added to the resulting oligocarbonate and the mixture was stirred at 180° C. for 8 h, during which methanol was removed as a by-product from the reaction mixture. This resulted in a waxy oligocarbonate diol having the following characteristic data:
Hydroxyl number (OHN): 53.0 mg KOH/g
Mₙ: 2100 g/mol
Hydroxyl functionality: 1.97
Content of terminal secondary hydroxyl groups: 75 mol %
Viscosity: 3500 mPas at 75° C.

### Comparative Example

314.5 g of 1,3-butanediol were heated to 120° C. in a multinecked flask having stirrer and reflux condenser, and dehydrated at 20 mbar for 2 h. Subsequently, under a nitrogen blanket, the oil bath was cooled to 110° C., 0.08 g of ytterbium(III) acetylacetonate were added and 444.5 g of dimethyl carbonate were metered in within 20 minutes. On completion of addition, the reaction mixture was kept under reflux for 24 h.

Afterwards, the reaction mixture was distilled, during which the methanol by-product and also traces of dimethyl carbonate were removed. The distillation was effected initially at 150° C. for 4 h and was continued at 180° C. for a further 4 h. Afterwards, the temperature was reduced to 130° C. and the pressure was lowered to <20 mbar. In addition, a nitrogen stream (2 l/h) was passed through the reaction mixture. Finally, the temperature was increased from 130° C. to 180° C., provided that the top temperature did not exceed 60° C. The reaction mixture was kept at this temperature for 6 h. The hydroxyl number (OHN) of 348.5 mg KOH/g showed that virtually no polymer degradation had taken place. In addition, the corresponding ¹H NMR showed large proportions of by-products which contaminated the product, so that it was unsuitable for further reactions, for example, with (poly)isocyanates.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for preparing an aliphatic oligocarbonate polyol having secondary OH groups and a number-average molecular weight of ≧500 g/mol which comprises
A) initially reacting an excess amount of an organic carbonate with a polyol having exclusively primary OH groups via a transesterification reaction to prepare an intermediate polymer having an average concentration of OH groups of ≦0.3 mol %, based on 1 mol of the intermediate polymer,
B) removing the cleavage products formed simultaneously during the transesterification reaction or subsequently together with excess unconverted carbonate, and, in a further step,
C) reacting the intermediate polymer with an aliphatic polyol which has at least one secondary OH group per molecule to obtain an aliphatic oligocarbonate polyol which has an average of ≧5 mol % of secondary OH groups, based on the total of all the OH groups present.

2. The process of claim 1 wherein the intermediate polymer from stage A) has an average concentration of OH groups of 0 to 0.05 mol %, based on 1 mol of the intermediate polymer.

3. The process of claim 1 wherein the aliphatic oligocarbonate polyol obtained after step C) has a content of secondary OH groups, based on the total of all the OH groups present, of 60 to 95 mol %.

4. The process of claim 2 wherein the aliphatic oligocarbonate polyol obtained after step C) has a content of secondary OH groups, based on the total of all the OH groups present, of 60 to 95 mol %.

5. An aliphatic oligocarbonate polyol having secondary OH groups and a number-average molecular weight of ≧500 g/mol which is prepared by a process comprising
A) initially reacting an excess amount of an organic carbonate with a polyol having exclusively primary OH groups via a transesterification reaction to prepare an intermediate polymer having an average concentration of OH groups of ≦0.3 mol %, based on 1 mol of the intermediate polymer,
B) removing the cleavage products formed simultaneously during the transesterification reaction or subsequently together with excess unconverted carbonate, and, in a further step,
C) reacting the intermediate polymer with an aliphatic polyol which has at least one secondary OH group per molecule to obtain an aliphatic oligocarbonate polyol which has an average of ≧5 mol % of secondary OH groups, based on the total of all the OH groups present.

6. The aliphatic oligocarbonate polyol of claim 5 wherein the aliphatic oligocarbonate polyol obtained after step C) has a content of secondary OH groups, based on the total of all the OH groups present, of 60 to 95 mol %.

7. The aliphatic oligocarbonate polyol of claim 5 wherein the aliphatic oligocarbonate polyol has an average OH functionality of 1.90 to 5.0.

8. The aliphatic oligocarbonate polyol of claim 6 wherein the aliphatic oligocarbonate polyol has an average OH functionality of 1.90 to 5.0.

9. The aliphatic oligocarbonate polyol of claim 5 wherein the aliphatic oligocarbonate polyol has a number-average molecular weight of 750 to 2500 g/mol.

10. The aliphatic oligocarbonate polyol of claim 6 wherein the aliphatic oligocarbonate polyol has a number-average molecular weight of 750 to 2500 g/mol.

11. The aliphatic oligocarbonate polyol of claim 7 wherein the aliphatic oligocarbonate polyol has a number-average molecular weight of 750 to 2500 g/mol.

12. The aliphatic oligocarbonate polyol of claim 8 wherein the aliphatic oligocarbonate polyol has a number-average molecular weight of 750 to 2500 g/mol.

13. A coating, dispersion, adhesive or sealant obtained using aliphatic oligocarbonate polyol of claim 5.
